(19) United States
(12) Patent Application Publication
(10) Pub. No.: US 2013/0209614 A1
(43) Pub. Date: Aug. 15, 2013

(54) FOOD COMPOSITIONS HAVING A REALISTIC MEAT-LIKE APPEARANCE AND TEXTURE

(71) Applicants: Karine Doare-Broux, Paris (FR); Pierre Reynes, Amiens (FR)

(72) Inventors: Karine Doare-Broux, Paris (FR); Pierre Reynes, Amiens (FR)

(73) Assignee: Nestec S.A., Vevey (CH)

(21) Appl. No.: 13/809,463

(22) PCT Filed: Jul. 5, 2011
(86) PCT No.: PCT/US11/01179

§ 371 Date: Mar. 5, 2013

Related U.S. Application Data
(60) Provisional application No. 61/399,520, filed on Jul. 13, 2010.

(51) Int. Cl. A23J 3/22

(52) U.S. Cl. CPC A23J 3/227
USPC 426/87; 426/656; 426/657

(57) ABSTRACT

The invention provides novel food compositions having a realistic meat-like appearance and texture. The compositions comprise from about 50 to about 98% functional proteins, from about 0.05 to about 2% of one or more cross-linking agents, and from about 2 to about 50% of one or more humectant plasticizers. The compositions are produced by heating a preconditioned mixture of the food components under pressure and then expanding the heated composition to form the food composition.

### CROSS REFERENCE TO RELATED APPLICATIONS

This application claims priority to U.S. Provisional Application Ser. No. 61/399,520 filed Jul. 13, 2010, the disclosure of which is incorporated herein by this reference.

### BACKGROUND OF THE INVENTION

1. Field of the Invention

The invention relates generally to food compositions and particularly to food compositions having a realistic meat-like appearance and texture and to methods of making such food compositions.

2. Description of Related Art

Various food compositions having a meat-like appearance and methods of making such food compositions are known in the art. For example, U.S. Pat. No. 4,910,025 discloses a simulated ground meat analog derived from sprouted whole grain kernels and the process for making the analog. U.S. Pat. No. 5,607,710 discloses a method and apparatus for forming meat analog products and for texturizing a dough mass wherein the ingredients are mixed, passed through a conduit having a decreasing cross-sectional area while the dough mass is heated therein, the heating being done such that a greater heat intensity is applied to the center of the dough mass than to the dough mass adjacent the walls of the conduit. U.S. Pat. No. 5,676,987 discloses low-fat meat foods with much of the flavor and physical properties of conventional full-fat meat foods. U.S. Pat. No. 7,070,827 discloses a process for making a vegetable base meat analog that can be used in a variety of vegetarian food products, such as burger patties and sausages. US2006105098A1 discloses a method of manufacturing a texturized proteinaceous meat analogue having a relative water activity of less than about 0.8, comprising proteinaceous materials selected from the group consisting of defatted soy flour, soy meal, soy concentrate, cereal gluten (in vital or starch containing form) and egg white powder, edible binding and cross-linking compounds, and a humectant of glycerol and glucose, and the products thereof. The mixture is converted into hot lava, extruded and cooled. US2006141125A1 discloses a proteinaceous meat analogue, for incorporation into packaged pet foods, wherein said meat analogue consists of particles of internally texturized, proteinaceous extrudate material dispersed in a gelled matrix composed of ground meat-based and cereal-based materials; wherein the moisture content of said extrudate and said matrix are different; and wherein the internal texturization of said extrudate has a fibrous structure. Also disclosed is a method of preparing said analogue. U.S. Pat. No. 5,869,121 discloses a moisture-reduced, formulated food product that has a soft, resilient texture and that simulates the appearance of cooked meat. U.S. Pat. No. 6,379,738 and U.S. Pat. No. 6,649,206 disclose methods for producing meat emulsion products that have a realistic fiber definition. The products have a body member including protein and fat and have a plurality of linear strands of fiber-like material affording the meat emulsion product a realistic meat-like appearance.

Generally, food compositions that have a meat-like appearance and texture require the addition of water to create the soft meat-like appearance and texture. These food compositions must be hermetically sealed and sterilized to be shelf stable, generally by retorting a sealed container containing the compositions. Typically, these food compositions are classified as “wet” food compositions by the food industry. To adapt these food compositions and produce “dry” food compositions having an acceptable meat-like appearance and texture requires lower levels of water. For such dry compositions to be shelf stable, preservatives must be added to prevent spoilage. Unfortunately, the soft texture of these dry compositions is quickly lost, possibly due to loss of moisture. Without the soft texture, these compositions do not have an acceptable meat-like appearance and texture and are therefore not very appealing or palatable.

One method for overcoming the problems discussed above and making food compositions having a meat-like appearance and texture is disclosed in U.S. Provisional Patent Application Ser. No. 61/204,182; U.S. patent application Ser. No. 12/381,548; and International Patent Application No. PCT/US09/06747. These food compositions are very palatable and have a realistic meat-like appearance and texture. However, the method requires using a meat slurry in the process. Use of a meat slurry in the process requires additional ingredients, steps, and equipment. It would be beneficial if similar or improved food compositions could be made without using a meat slurry in the process.

There is, therefore, a need for new food compositions that have and retain a realistic meat-like appearance and texture and for methods for producing such food compositions.

### SUMMARY OF THE INVENTION

It is, therefore, an object of the present invention to provide new food compositions having a realistic meat-like appearance and texture.

It is another object of the invention to provide new methods for producing food compositions having a realistic meat-like appearance and texture.

It is a further object of the invention to provide new methods for producing food compositions having a realistic meat-like appearance and texture without using a meat slurry in the methods.

It is another object of the invention to provide new food compositions with enhanced palatability.

It is a further object of the invention to provide blended food compositions with enhanced palatability.

One or more of these or other objects are achieved using novel food compositions having a realistic meat-like appearance and texture and novel methods for making such food compositions. The food compositions comprise from about 50 to about 98% functional proteins, from about 0.05 to about 2% of one or more cross-linking agents, and from about 2 to about 50% of one or more humectant plasticizers. The compositions are produced by heating a preconditioned mixture of the food components under pressure and then expanding the heated composition to form the food composition. The new food compositions are highly palatable and can be fed alone or blended with other comestible foods to enhance the palatability of the blend. Advantages of the invention are that the food compositions having a realistic meat-like appearance and texture can be made without (1) using real meat, an expensive ingredient that must be handled with care, and (2) using a step in the method that requires a meat slurry.

Additional and further objects, features, and advantages of the invention will be readily apparent to those skilled in the art.

### DETAILED DESCRIPTION OF THE INVENTION

### Definitions

The term “animal” means any animal that could benefit from or enjoy the consumption of food compositions of the present invention, including human, avian, bovine, canine, equine, feline, hicrine, lupine, murine, piscine, ovine, or porcine animals.

The term “companion animal” means domesticated animals such as cats, dogs, rabbits, guinea pigs, ferrets, hamsters, mice, gerbils, horses, cows, goats, sheep, donkeys, pigs, and the like.

The term “food composition” means a product or composition that is intended for ingestion by an animal.

The term “meat” means edible flesh of animals including avian, piscine, bovine, equine, ovine, or porcine animals. Meat includes muscle tissue, mechanically deboned tissue, organs, or combinations thereof. The term “meat” does not include rendered meat meals.

The term “meat slurry” means a liquefied meat product that contains fewer fats and pigments and less myoglobin than unprocessed meats. Meat slurry is for general consumption; it is typically used in the processes for producing food products for humans and domestic animals, e.g., chicken nuggets and pet foods. Meat slurry and methods for making and using meat slurry in foods and food production processes are common and known to skilled artisans.

The term “functional proteins” means (1) undenatured or partially denatured proteins that affect the structure of a food composition after heating or (2) a mixture comprising from about 20 to about 80% of undenatured or partially denatured proteins such as soy flour and wheat gluten that affect the structure of a food composition after heating and from about 80 to about 20% of other proteins such as rendered protein meals.

The term “Aw” means water activity.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual food compositions physically associated such that they are considered a unit for manufacture, distribution, sale, or use.

The term “virtual package” means that the components of a kit are associated by directions on one or more physical or virtual kit components instructing the user how to obtain the other components, e.g., in a bag or other container containing one component and directions instructing the user to go to a website, contact a recorded message or a fax-back service, view a visual message, or contact a caregiver or instructor to obtain instructions on how to use the kit or safety or technical information about one or more components of a kit.

All percentages expressed herein are by weight of the total weight of the composition unless expressed otherwise.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a supplement”, “a method”, or “a food” includes a plurality of such “supplements”, “methods”, or “foods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### THE INVENTION

In one aspect, the invention provides food compositions having a realistic meat-like appearance and texture. The compositions comprise from about 50 to about 98% functional proteins, from about 0.05 to about 2% of one or more cross-linking agents, and from about 2 to about 50% of one or more humectant plasticizers. The invention is based upon the discovery that heating specific amounts of a mixture of functional proteins, cross-linking agents, and one or more humectant plasticizers results in a food composition that has a realistic meat-like appearance and texture. In addition, the food compositions are highly palatable compared to similar food compositions. Further, the food compositions have a moisture content and water activity that eliminates or minimizes spoilage under ambient conditions and eliminates the need artificial preservatives such as mold inhibitors.

In some embodiments, the compositions comprise from about 60 to about 98% functional proteins, from about 0.05 to about 2% of one or more cross-linking agents, and from about 2 to about 40% of one or more humectant plasticizers. In others, the compositions comprise from about 70 to about 98% functional proteins, from about 0.05 to about 2% of one or more cross-linking agents, and from about 2 to about 30% of one or more humectant plasticizers. In still others, the compositions comprise from about 80 to about 98% functional proteins, from about 0.05 to about 2% of one or more cross-linking agents, and from about 2 to about 20% of one or more humectant plasticizers. In still another, the compositions comprise from about 90 to about 98% functional proteins, from about 0.05 to about 2% of one or more cross-linking agents, and from about 2 to about 10% of one or more humectant plasticizers.

In various embodiments, the functional proteins are legume proteins, cereal proteins, or combinations thereof. In a preferred embodiment, the functional proteins are cereal proteins such as wheat gluten. In other embodiments, the functional proteins are legume proteins such as soy isolates or soy flour. In other embodiments, functional proteins are a mixture of (1) from about 20 to about 80% of legume proteins, cereal proteins, or combinations thereof and (2) from about 80 to about 20% of one or more other proteins, e.g., vegetable proteins such as soybean meal, corn gluten, rice gluten and meat protein meals such as beef, chicken, turkey, and fish meals. The components of the functional proteins comprise, in various embodiments, many combinations of the ingredients.

The cross-linking agents can be any cross-linking agent suitable for use with the food compositions. Useful cross-linking agents include elemental sulfur, sodium metabisulfite, cysteine, or combinations thereof.

In various embodiments, the cross-linking agents comprise from about 0.1 to about 1.8%, preferably from about 0.2 to about 1.5%, most preferably from about 0.3 to about 1%.

The humectant plasticizers can be any humectant plasticizers that have humectant properties and that are compatible with the food compositions. In various embodiments, the humectant plasticizers are polyols. In preferred embodiments, the humectant plasticizers are one or more of glycerol (glycerin), sorbitol, propylene glycol, butylene glycol, polydextrose, or combinations thereof.

In various embodiments, the humectant plasticizers comprise from about 3 to about 35% of the food composition, from about 5 to about 30%, from about 7 to about 25%, from about 9 to about 20%, and from about 10 to about 15% of the food compositions.

In various embodiments, the functional proteins comprise from about 65 to about 95% and the humectant plasticizers comprise from about 5 to about 35% of the food compositions. In others, the functional proteins comprise from about 70 to about 90% and the humectant plasticizers comprise from about 10 to about 30% of the food compositions. In still others, the functional proteins comprise from about 75 to about 90% and the humectant plasticizers comprise from about 20 to about 25% of the food compositions. In one embodiment, the functional proteins comprise about 80% and the humectant plasticizers comprise about 20% of the food compositions.

In various embodiments, the food compositions have an Aw of about 0.75 or less, preferably about 0.65 or less. In preferred embodiments, the food compositions have an Aw of from about 0.4 to about 0.75, preferably from about 0.45 to about 0.65, most preferably from about 0.5 to about 0.62.

In various embodiments, the food compositions have a moisture content of about 14% or less, preferably about 12% or less, most preferably about 10% or less. In preferred embodiments, the food compositions have a moisture content of from about 4 to about 14%, preferably from about 6 to about 12%, most preferably from about 8 to about 10%.

In certain embodiments, the humectant plasticizers comprise from about 6 to about 15% of the food composition, the Aw of the food composition is about 0.62 or less, and the moisture content of the food composition is from about 6 to about 14%.

In various embodiments, the compositions comprise additional ingredients such as vitamins, minerals, amino acids, nucleic acids, fillers, palatability enhancers, binding agents, flavors, stabilizers, emulsifiers, sweeteners, colorants (e.g., titanium dioxide), buffers, salts, coatings, condiments, preservatives, and the like known to skilled artisans. Non-limiting examples of supplementary minerals include calcium, phosphorous, potassium, sodium, iron, chloride, boron, copper, zinc, magnesium, manganese, iodine, selenium, and the like. Non-limiting examples of supplementary vitamins include vitamin A, any of the B vitamins, vitamin C, vitamin D, vitamin E, and vitamin K, including various salts, esters, or other derivatives of the foregoing. Additional dietary supplements may also be included, for example, any form of niacin, pantothenic acid, inulin, folic acid, biotin, amino acids, and the like, as well as salts and derivatives thereof. Stabilizers include substances that tend to increase the shelf life of the composition such as preservatives, synergists and sequestrants, packaging gases, emulsifiers, thickeners, and gelling agents. Examples of emulsifiers and/or thickening agents include gelatin, cellulose ethers, starch, starch esters, starch ethers, and modified starches. Selection of the ingredients and their amounts is known to skilled artisans. Specific amounts for each additional ingredient will depend on a variety of factors such as the ingredient included in the composition; the species of animal; the animal's age, body weight, general health, sex, and diet; the animal's consumption rate; the purpose for which the food composition is being administered to the animal; and the like. Therefore, the component and ingredient amounts may vary widely and may deviate from the preferred proportions described herein. In such embodiments, such additional ingredients typically comprise from about 0.01 to about 20% of the food composition, preferably from about 0.01 to about 15%.

In one embodiment, the food compositions are formulated to provide “complete and balanced” nutrition for an animal, preferably a companion animal, according to standards established by the Association of American Feed Control Officials (“AAFCO”). In another embodiment, the food composition is a pet food composition. In preferred embodiments, the food compositions are nutritionally complete and provide a balanced diet, i.e., the food composition includes vitamins and minerals at the recommended daily levels. Such food composition can be fed solely or blended in various proportions with other food ingredients, e.g., dry petfood kibbles suitable for dogs or cats. Alternatively, the food compositions can be formulated as a treat that is not nutritionally complete.

In various embodiments, the food compositions contain at least one of (1) one or more probiotics; (2) one or more killed or inactivated probiotics; (3) components of the killed or inactivated probiotics that promote health benefits similar to or the same as the live, killed, or inactivated probiotics, e.g., proteins, lipids, glycoproteins, and the like; (4) one or more prebiotics; and (5) combinations thereof. The probiotics or their components can be integrated into the food compositions (e.g., uniformly or non-uniformly distributed in the composition) or applied to the food compositions (e.g., topically applied with or without a carrier). In one embodiment, the probiotics are encapsulated in a carrier. Typical probiotics include, but are not limited to, probiotic strains selected from Lactobacilli, Bifidobacteria, or Enterococci, e.g., Lactobacillus reuteri, Lactobacillus acidophilus, Lactobacillus animalis, Lactobacillus ruminis, Lactobacillus johnsonii, Lactobacillus casei, Lactobacillus paracasei, Lactobacillus rhamnosus, Lactobacillus fermentum, and Bifidobacterium sp., Enterococcus faecium and Enterococcus sp. In some embodiments, the probiotic strain is selected from the group consisting of Lactobacillus reuteri (NCC2581; CNCM 1-2448), Lactobacillus reuteri (NCC2592; CNCM 1-2450), Lactobacillus rhamnosus (NCC2583; CNCM 1-2449), Lactobacillus reuteri (NCC2603; CNCM 1-2451), Lactobacillus reuteri (NCC2613; CNCM 1-2452), Lactobacillus acidophilus (NCC2628; CNCM 1-2453), Bifidobacterium adolescentis (e.g., NCC2627), Bifidobacterium sp. NCC2657 or Enterococcus faecium SF68 (NCIMB 10415). The food compositions contain probiotics in amounts sufficient to supply from about 10⁴ to about 10¹² cfu/animal/day, preferably from 10⁵ to about 10″ cfu/animal/day, most preferably from 10⁷ to 10¹⁰ cfu/animal/day. When the probiotics are killed or inactivated, the amount of killed or inactivated probiotics or their components should produce a similar beneficial effect as the live microorganisms. Many such probiotics and their benefits are known to skilled artisans, e.g., EP1213970B1, EP1143806B1, U.S. Pat. No. 7,189,390, EP1482811B1, EP1296565B1, and U.S. Pat. No. 6,929,793. In a preferred embodiment, the probiotic is Enterococcus faecium SF68 (NCIMB 10415).

As stated, the food compositions may contain one or more prebiotics, e.g., fructo-oligosaccharides, gluco-oligosaccharides, galacto-oligosaccharides, isomalto-oligosaccharides, xylo-oligosaccharides, soybean oligosaccharides, lactosucrose, lactulose, and isomaltulose. In one embodiment, the prebiotic is chicory root, chicory root extract, inulin, or combinations thereof. Generally, prebiotics are administered in amounts sufficient to positively stimulate the healthy microflora in the gut and cause these “good” bacteria to reproduce. Typical amounts are from about one to about 10 grams per serving or from about 5% to about 40% of the recommended daily dietary fiber for an animal. The probiotics and prebiotics can be made part of the composition by any suitable means. Generally, the agents are mixed with the composition or applied to the surface of the composition, e.g., by sprinkling or spraying. When the agents are part of a kit, the agents can be admixed with other materials or in their own package. Typically, the food composition contains from about 0.1 to about 10% prebiotic, preferably from about 0.3 to about 7%, most preferably from about 0.5 to 5%, on a dry matter basis.

In another aspect, the invention provides blended food compositions comprising (1) a food composition of the present invention and (2) one or more other comestible ingredients or compositions. The comestible ingredient or composition can be any comestible ingredient or composition compatible with the food compositions of the present invention. Preferably, the comestible composition is one or more dry kibbles suitable for consumption by companion animals, preferably dogs and cats. Preferably the comestible ingredient or composition is selected from the group consisting of extruded kibbles, baked kibbles, extruded treats, and baked treats. In some embodiments, the comestible ingredient is real meat pieces, preferably in the form of real meat chunks.

In preferred embodiments, the comestible ingredients or compositions have a moisture content of about 12% or less and an Aw of about 0.75 or less, preferably 0.65 or less, most preferably 0.62 or less. In one preferred embodiment, the comestible composition is a food composition disclosed in U.S. Provisional Patent Application Ser. No. 61/204,182; U.S. patent application Ser. No. 12/381,548; and International Patent Application No. PCT/US09/06747.

The blended food compositions of the invention comprise any suitable amount of a food composition of the present invention. Generally, the food compositions comprise from about 1 to about 99% for the blended food composition, preferably from about 5 to about 99%, most preferably from about 5 to about 95%. The blended food composition has enhanced palatability compared to food compositions comprising the comestible food ingredients or compositions alone.

In one embodiment, the blended food compositions are formulated to provide “complete and balanced” nutrition for an animal, preferably a companion animal, according to standards established by the Association of American Feed Control Officials (AAFCO). In another embodiment, the food composition is a pet food composition.

In various embodiments, the animal is a companion animal, preferably a dog or a cat, most preferably a dog.

Whether alone or blended, the food compositions of the invention can be are coated with a fats and other palatability enhancers, e.g., animal digest.

In another aspect, the invention provides methods for making food compositions comprising (1) mixing one or more functional proteins and one or more cross-linking agents to produce a base mix; (2) mixing the base mix and one or more humectant plasticizers to form a preconditioned mix; (4) heating the preconditioned mix under pressure; and (5) expanding the heated composition to form the food composition. The resulting food compositions have a realistic meat-like appearance and texture. Further, the food compositions have a moisture content and water activity that eliminates or minimizes spoilage and eliminates the need artificial preservatives such as mold inhibitors. Advantageously, the food compositions are made without using a meat slurry.

In various embodiments, the functional proteins are legume proteins, cereal proteins, or combinations thereof. Typically, these functional proteins are mostly undenatured, e.g., soy flour with greater than a 70 protein dispersibility index, soy bean meal with a protein dispersibility index of 20 or higher, soy flakes with a protein dispersibility index of 50 or higher, or vital wheat gluten. Generally, functional proteins include any soy bean derivative including meal, flour, concentrate, flakes, and isolates with a protein dispersibility index of 20 or higher.

In various embodiments, the cross-linking agents are elemental sulfur, sodium metabisulfite, cysteine, or combinations thereof. Typically, the cross-linking agent comprises from about 0.01 to about 2% of the food composition, preferably form about 0.05 to about 2%, most preferably form about 0.1 to about 1%.

Generally, a base mix is made by mixing one or more functional proteins and one or more cross-linking agents in amounts of from about 98 to about 99.95% functional proteins and from about 0.05 to about 2% cross-linking agents. The base mix is made by placing the functional proteins and the cross-linking agents in a container and stirring, preferably until the mixture is homogenous.

In some embodiments, the base mix is made as described above except that additional proteins such as vegetable proteins (e.g., soybean meal, corn gluten, and/or rice gluten) and/or meat protein meals (e.g., beef, chicken, turkey, and/or fish meals) are used as an ingredient in the base mix. When used, these additional proteins generally comprise from about 15 to about 40% of the base mix, but amounts may vary as described herein.

Generally, a preconditioned mix is formed by mixing the base mix and the humectant plasticizers in amounts of from about 70 to about 95% base mix and from about 5 to about 30% humectant plasticizer(s) and heating the mixture to a temperature of from about 160 to about 245° F. (about 71 to about 118° C.). In one embodiment, the preconditioned mix is formed by mixing the base mix and the humectant plasticizer(s) in amounts of from about 70 to about 85% base mix and from about 15 to about 30% humectant plasticizer(s) and heating the mixture to a temperature of from about 160 to about 212° F. (about 71 to about 100° C.). If wanted or desired, colorants can be added to the premix, particularly if colorants were not added to the base mix.

Generally, the preconditioned mix is heated to temperatures of from about 280 to about 420° F. (about 135 to about 215° C.), from about 310 to about 380° F. (about 155 to about 195° C.), at pressures of greater than from about 400 psi, preferably pressures of from about 400 psi to about 1000 psi, most preferably from about 400 psi to about 800 psi. Then, the heated mix is allowed to expand by removing the pressure, typically by removing the heated mix from the device used to heat the preconditioned mix and exposing the heated mix to atmospheric pressure.

Any device suitable for heating the preconditioned mix under pressure and then allowing the heated mixture to expand, typically by removing the pressure, is suitable for making the compositions of the invention.

In one embodiment, the food compositions are produced using an extrusion process. In the extrusion process, the preconditioned mix is fed to an extruder where the preconditioned mix is subjected to shear, pressure, temperature and/or other process conditions suitable for forming a processed food composition that can be used to make the food composition of the invention. Then, the processed food composition exits the extruder where it expands to form the food compositions of the invention. Such extrusion processes are known to skilled artisans.

In one extrusion process, the preconditioned mix is subjected to shear and further mixing between the rotating extruder screw and the barrel. The screw profile is one designed to impart high shear as known to skilled artisans. The shear, the additional frictional heat, and high pressure (generally greater than 400 psi) produces a molten mass having a temperature of from about 310 to about 380° F. (about 154 to about 193° C.). Upon exiting the extruder, the food molten mass expands to form the food compositions of the invention.

In one embodiment, the moisture of the food composition is from about 12 to about 30% upon exiting the extruder. In another, the moisture of the food composition is from about 14 to about 20% upon exiting the extruder. Evaporative loss lowers the moisture content to from about 7 to about 14% or from about 10 to 14%. If evaporative loss does not lower the moisture to the desired level, the moisture content can be lowered by drying. In this embodiment, the density of the food composition is from about 9 to about 17 lbs/bushel (BU) (about 115 to about 220 grams/liter). The resulting expanded structure of the food composition is highly absorbent and easily absorbs flavoring liquids, if desired.

Other suitable devices can also be used to create an extrusion-like process. For example, heat exchangers that create process conditions such as high pressures and temperatures equivalent to or similar to those created by extruders. Other such devices may be known to skilled artisans.

Food compositions containing probiotics are produced by mixing the probiotic with the food ingredients at any stage of the process so that the probiotics are dispersed in the food composition, preferably uniformly dispersed. Preferably, such probiotics are encapsulated if they are to be inserted into the process before the heating stage. Alternatively, the probiotics are applied to the surface of the food composition, with or without a carrier. Preferably, the probiotics are sprayed onto the food composition. For animal foods, the probiotics can be sprayed onto the surface of the food composition as an ingredient in lipid or other based palatability enhancers. In one embodiment, the probiotics are simply applied to the food composition just before consumption, by mixing with or sprinkling onto the food composition.

Food compositions containing prebiotics are produced by mixing the prebiotic with the food ingredients at any stage of the process so that the prebiotics are dispersed in the food composition, preferably uniformly dispersed.

It is believed, without being bound by theory, that the cross-linking agents promote disulfide links that create a matrix in the composition that is responsible for the realistic meat-like appearance and texture. The matrix is created by the expansion of the food composition as it exits the extruder, the pressure of the composition drops from the elevated pressures in the extruder to atmospheric pressure outside the extruder, typically from greater than about 400 psi to atmospheric pressure. The expansion creates a striated or fibrous appearance that produces the realistic meat-like appearance and texture characteristic of the novel food composition.

In another aspect, the invention provides food compositions made according to the methods of the invention.

In a further aspect, the invention provides kits suitable for administering the food compositions of the invention to an animal. The kits comprise in separate containers in a single package or in separate containers in a virtual package, as appropriate for the kit component, a food composition of the present invention and one or more of (1) one or more comestible ingredients or compositions suitable for consumption by an animal; (2) instructions for how to combine the food composition with the comestible ingredients or compositions, particularly to produce a blended food composition of the present invention; (3) one or more probiotics; (4) one or more prebiotics; (5) one or more killed or inactivated probiotics; (6) instructions for how to combine the food composition with the probiotics and prebiotics; (7) one or more devices for mixing kit components or containing the admixture; and (8) instructions for how to use food compositions and other components of the kit; particularly to enhance the palatability of comestible ingredients or compositions, to promote gastrointestinal health using the probiotics and prebiotics, or to use the devices to prepare and serve the food compositions.

When the kit comprises a virtual package, the kit is limited to instructions in a virtual environment in combination with one or more physical kit components. The kit contains food compositions and other components. Typically, the food compositions and the other suitable kit components (e.g., comestible ingredients) are admixed just prior to consumption by an animal. The kits may contain the kit components in any of various combinations and/or mixtures. In one embodiment, the kit contains a container comprising a food composition of the invention and a container comprising one or more other comestible ingredients or compositions, e.g., pet food kibbles. The kit may contain additional items such as a device for mixing kit components or a device for containing the admixture, e.g., a spoon and/or a food bowl. In another embodiment, the food compositions are mixed with additional nutritional supplements such as vitamins and minerals that promote good health in an animal. In one embodiment, the kit comprises a food composition of the invention and one or more probiotics in a sachet.

In another aspect, the invention provides a means for communicating information about or instructions for one or more of (1) the unique texture and appearance of the food compositions of the present invention; (2) the lack of preservatives in the food compositions; (3) the spoilage and shelf-stable characteristics of the food compositions; (4) instructions for feeding the food compositions or blended food compositions to animals; (5) contact information for consumers to use if they have a question about the food compositions or their use; (6) instructions for combining the kit components of the invention to produced food compositions; or (7) nutritional information about the food compositions. Useful instructions can include feeding amounts and frequency. The communication means is useful for instructing on the benefits of using the present invention and communicating the approved methods for feeding the food compositions to an animal. The means comprises one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

In another aspect, the invention provides a package comprising a food composition of the present invention, blended or un-blended, and a label affixed to the package containing a word or words, picture, design, acronym, slogan, phrase, or other device, or combination thereof that indicates that the contents of the package contains a food composition with beneficial properties such as shelf stability, desirable texture, desirable appearance, and lack of preservatives. Typically, such device comprises the words “contains no preservatives”, “softness assured”, “shelf-stable”, “no added water”, “enhanced palatability”, or an equivalent expression printed on the package. Any package or packaging material suitable for containing the composition is useful in the invention, e.g., bag, box, bottle, can, pouch, and the like manufactured from paper, plastic, foil, metal, and the like. In a preferred embodiment, the package contains a food composition adapted for a particular animal such as a human, canine, or feline, as appropriate for the label, preferably a companion animal food composition for dogs or cats. In a preferred embodiment, the package is a retortable can or pouch comprising a food composition of the present invention.

### EXAMPLES

The invention can be further illustrated by the following examples, although it will be understood that these examples are included merely for purposes of illustration and are not intended to limit the scope of the invention unless otherwise specifically indicated.

### Example 1

### Making a Base Mix

1200 kilograms of vital wheat gluten, about 500 kilograms of poultry by-products meal, and about 98 kilograms of whole wheat were mixed until homogeneous. About 90 kilograms of a mixture comprising salts, vitamins, minerals, amino acids, calcium salts, phosphates, and sulfur was added to this mixture and mixed until homogeneous to produce a base mix.

### Example 2

### Making a Preconditioned Mix

1200 kilograms of the base mix from Example 1, 220 kilograms of water and 120 kilograms of Monopropylene Glycol (MPG) were combined with stirring until the mixture was homogeneous to produce a preconditioned mix.

### Example 3

### Extruding the Composition

The preconditioned mix from Example 2 was heated using extrusion to a temperature of about 160° C. and extruded to produce food composition pieces that have a realistic meat-like appearance and texture.

### Example 4

### Coating the Food Composition

500 kilograms of food composition pieces from Example 3 were coated with 40 kilograms of lard. Analysis of the resulting food composition (“Analog”) showed that the composition comprises about 56% protein, 11% fat, and 14% moisture and that the composition had an Aw of about 0.64 and a density of about 200 g/l.

### Example 5

### Palatability Test

Standard dog food kibbles (“Kibble”) available for purchase were obtained and mixed with the food composition from Example 4 (“Analog”) (80% Kibbles and 20% Analog) The composition was tested for palatability using a two-bowl palatability test. The results are shown in Table 1.

TABLE 1

| Ration | Ration B | | |
|---|---|---|---|
| A | Blended Analog | % A | % B |
| Control | and ibble | Consumed | Consumed |
| Kibble | 80% Kibble:20% Analog | 39 | 61 |

Referring to Table 1, the result shows that the blended food compositions showed enhanced palatability. The blended food composition was about 1 to about 3 times more palatable than the kibble composition alone.

### Example 6

### Visual Test

The Analog and Kibble composition as defined above were compared for appearance by visually observing the Analog and the Kibble. The Analog looked like a piece of real meat; the Kibble looked like a cereal product and did not appear to be a piece of real meat.

### Example 7

### Texture Test

Standard dog food soft compositions (“Soft Pieces”) available for purchase, standard dry kibbles available for purchase (“Dry Kibbles”), and Analog as defined above were tested and compared for texture by feeling the Soft Pieces, Dry Kibbles, and Analog and by testing the Soft Pieces, Dry Kibbles, and Analog for compression pressure.

Compression tests were done with an TAXT-2. Measurements were carried out with a cylindrical probe with a flat surface of 0.65 mm diameter (0.25 inch). A crosshead speed of 0.85 mm/s (2 inches per minute) was used to compress the kibble placed on a flat plate. The samples were compressed at 70% of their height. At least 10 pieces were measured and the means used for comparison. These results showed that food composition had similar soft characteristics to a commercial soft composition that does not possess the striated appearance of the food compositions of the present invention.

Visually, the Analog looked like a piece of real meat, the Soft Pieces did not look like a piece of real meat but instead looked like a cereal product and the Dry Kibbles looked also like a cereal product. The results of the compression test are shown in Table 2.

TABLE 2

| | Distance (mm) Reached at | Breaking Point: Percent |
|---|---|---|
| Product | 10 Newton | of Pieces Height |
| Dry Kibbles | 0.35 | 19.4% (Broken) |
| Soft Pieces | 0.93 | Not Broken at 72.0% |
| Analog | 2.13 | Not Broken at 76.9% |

Soft Pieces and Analog are both softer and more elastic than the Dry Kibbles. The Dry Kibble is breakable compared to Soft Pieces and Analog. Moreover, the Analog is softer and more tender than the Soft Pieces; the Analog is easier to bite through.

Referring to Table 2, the data shows that the Analog feels like a piece of real meat, the Soft Pieces feels somewhat like a piece of real meat, and the Dry Kibbles did not feel like a piece of real meat. Referring to the visual test and the feel test, the advantage of the Analog is that it has both a meat-like appearance and a meat-like feel and texture. Soft dry food compositions available commercially convey a meaty feel. These soft dry compositions also use humectant plasticizers. However, their internal structure is cellular like regular kibbles. Therefore the current soft dry compositions feel meaty but do not look meaty. In contrast, the Analog of the present invention looks meaty and feels meaty.

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

1. A food composition comprising from about 50 to about 98% functional proteins, from about 0.05 to about 2 of one or more cross-linking agents, and from about 2 to about 50% of one or more humectant plasticizers.

2. The composition of claim 1 wherein the functional proteins are legume proteins, cereal proteins, and combinations thereof.

3. The composition of claim 1 wherein the functional proteins are cereal proteins.

4. The composition of claim 1 wherein the functional protein is wheat gluten.

5. The composition of claim 1 wherein the functional proteins are legume proteins.

6. The composition of claim 1 wherein the functional proteins are soy isolates or soy flour.

7. The composition of claim 1 wherein the functional proteins are a mixture of (1) from about 20 to about 80% of legume proteins, cereal proteins, and combinations thereof and (2) from about 80 to about 20% of one or more other proteins.

8. The composition of claim 7 wherein the functional proteins are cereal proteins.

9. The composition of claim 7 wherein the functional protein is wheat gluten.

10. The composition of claim 7 wherein the functional proteins are legume proteins.

11. The composition of claim 7 wherein the functional proteins are soy isolates or soy flour.

12. The composition of claim 7 wherein the other proteins are vegetable proteins, meat protein meals, and combinations thereof.

13. The composition of claim 12 wherein the vegetable proteins are soybean meal, corn gluten, rice gluten, and combinations thereof.

14. The composition of claim 12 wherein the meat protein meals are beef meal, chicken meal, turkey meal, fish meal, and combinations thereof.

15. The composition of claim 1 wherein the cross-linking agents are elemental sulfur, sodium metabisulfite, cysteine, and combinations thereof.

16. The composition of claim 1 wherein the humectant plasticizers are polyols.

17. The composition of claim 16 wherein the polyols are selected from the group consisting of glycerol, sorbitol, propylene glycol, butylene glycol, polydextrose, and combinations thereof.

18. The composition of claim 16 wherein the polyol is propylene glycol.

19. The composition of claim 1 comprising from about 5 to about 25% humectant plasticizers.

20. The composition of claim 1 comprising from about 8 to about 20% humectant plasticizers.

21. The composition of claim 1 comprising from about 6 to about 15% humectant plasticizers.

22. The composition of claim 1 wherein the Aw is from about 0.4 to about 0.75.

23. The composition of claim 1 wherein the Aw is from about 0.45 to about 0.65.

24. The composition of claim 1 wherein the Aw is about 0.75 or less.

25. The composition of claim 1 wherein the moisture content is about 16% or less.

26. The composition of claim 1 wherein the moisture content is about 14% or less.

27. The composition of claim 1 wherein the moisture content is about 12% or less.

28. The composition of claim 1 wherein the moisture content is from about 4 to about 16%.

29. The composition of claim 1 wherein the moisture content is from about 6 to about 14%.

30. The composition of claim 1 wherein the moisture content is from about 8 to about 12%.

31. The composition of claim 1 formulated to provide complete and balanced nutrition for an animal.

32. The composition of claim 31 wherein the animal is at companion animal.

33. The composition of claim 31 wherein the animal is a dog or a cat.

34. The composition of claim 1 further comprising at least one of (1) one or more probiotics; (2) one or more killed or inactivated probiotics; (3) components of the killed or inactivated probiotics that promote health benefits similar to or the same as the live, killed, or inactivated probiotics; (4) one or more prebiotics; and (5) combinations thereof.

35. A blended food composition comprising:
(1) from about 5 to about 99% of a food composition comprising from about 50 to about 98% functional proteins, from about 0-0.05 to about 2% of one or more cross-linking agents, and from about 2 to about 50% of one or more humectant plasticizers; and
(2) one or more comestible ingredients or compositions suitable for consumption by an animal.

36. The blended food composition of claim 35 wherein the comestible ingredients or compositions are one or more kibbles.

37. The blended food composition of claim 35 wherein the comestible ingredients or compositions have a moisture content of about 12% or less and an Aw of about 0.75 or less.

38. The blended food composition of claim 35 wherein the comestible ingredient is selected from the group consisting of extruded kibbles, baked kibble extruded treats, and baked treats.

39. The blended food composition of claim 35 wherein the comestible ingredient and the food composition have a moisture content less than about 12% and Aw of less than about 0.75.

40. A method of making a food composition comprising:
(1) mixing one or more functional proteins and one or more cross-linking agents to produce a base mix;
(2) mixing the base mix and one or more humectant plasticizers to form a preconditioned mix;
(4) heating the preconditioned mix under pressure; and
(5) expanding the heated composition to form the food composition.

41. The method of claim 40 wherein the base mix is made by mixing one or more functional proteins and one or more cross-linking agents in amounts of from about 98 to about 99.95% functional proteins and from about 0.05 to about 2% cross-linking agents.

42. The method of claim 40 wherein the functional proteins are legume proteins, cereal proteins, and combinations thereof.

43. The method of claim 40 wherein the functional proteins are cereal proteins.

44. The method of claim 40 wherein the functional protein is wheat gluten.

45. The method of claim 40 wherein the functional proteins are legume proteins.

46. The method of claim 40 wherein the functional proteins are soy isolates or soy flour.

47. The method of claim 40 wherein the functional proteins are a mixture of (1) from about 20 to about 80% of legume proteins, cereal proteins, and combinations thereof and (2) from about 80 to about 20% of one or more other proteins.

48. The method of claim 47 wherein the functional proteins are cereal proteins.

49. The method of claim 47 wherein the functional protein is wheat gluten.

50. The method of claim 47 wherein the functional proteins are legume proteins.

51. The method of claim 47 wherein the functional proteins are soy isolates or soy flour.

52. The method of claim 47 wherein the other proteins are vegetable proteins, meat protein meals, and combinations thereof.

53. The method of claim 52 wherein the vegetable proteins are soybean meal, corn gluten, rice gluten, and combinations thereof.

54. The method of claim 52 wherein the meat protein meals are beef meal, chicken meal, turkey meal, fish meal, and combinations thereof.

55. The method of claim 47 wherein the cross-linking agents are selected from the group consisting of elemental sulfur, sodium metabisulfite, cysteine, or a combination thereof.

56. The method of claim 47 wherein the humectant plasticizers are polyols.

57. The method of claim 47 wherein the humectant plasticizers are selected from the group consisting of glycerol, sorbitol, propylene glycol, butylene glycol, polydextrose, and combinations thereof.

58. The method of claim 47 wherein the preconditioned mix is heated to a temperature of from about 135° C. to about 215° C.

59. The method of claim 47 wherein the preconditioned mix is heated to a temperature of from about 155° C. to about 195° C.

60. A kit suitable for administering the food compositions of the present invention to an animal comprising in separate containers in a single package or in separate containers in a virtual package, as appropriate for the kit component, a food composition of claim 1 and one or more of (1) one or more comestible ingredients or compositions suitable for consumption by an animal; (2) instructions for how to combine the food composition with the comestible ingredients or compositions, particularly to produce a blended food composition of the present invention; (3) one or more probiotics; (4) one or more prebiotics; (5) one or more killed or inactivated probiotics; (6) instructions for how to combine the food composition with the probiotics and prebiotics; (7) one or more devices for mixing kit components or containing the admixture; and (8) instructions for how to use food compositions and other components of the kit; particularly to enhance the palatability of comestible ingredients or compositions, to promote gastrointestinal health using the probiotics and prebiotics, or to use the devices to prepare and serve the food compositions.

61. A means for communicating information about or instructions for one or more of (1) the unique texture and appearance of the food compositions of claim 1 or claim 29; (2) the lack of preservatives in the food compositions; (3) the spoilage and shelf-stable characteristics of the food compositions; (4) instructions for feeding the food compositions or blended food compositions to animals; (5) contact information for consumers to use if they have a question about the food compositions or their use; (6) instructions for combining the kit components of the invention to produced food compositions; or (7) nutritional information about the food compositions.

62. The means of claim 61 selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

63. A package comprising it food composition of claim 1 and a label affixed to the package containing a word or words, picture, design, acronym, slogan, phrase, or other device, or combination thereof that indicates that the contents of the package contains a food composition with beneficial properties.

64. The package of claim 63 wherein the beneficial properties are improved palatability.

65. A package comprising a food composition of claim 29 and a label affixed to the package containing a word or words, picture, design, acronym, slogan, phrase, or other device, or combination thereof indicates that the contents of the package contains a food composition with beneficial properties.

66. The package of claim 65 wherein the beneficial are improved palatability.

67. A food composition made according to the method of claim 47.
